(19) United States
(12) Patent Application Publication
(10) Pub. No.: US 2002/0180662 A1
(43) Pub. Date: Dec. 5, 2002

(54) Optical system for head mounted display

(75) Inventors: Han Il Ko, Suwon-si (KR); Jin Goo Kim, Suwon-si (KR); Jong Bae Park, Suwon-si (KR)

Correspondence Address: LOWE HAUPTMAN GOPSTEIN, GILMAN & BERNER, LLP, SUITE 310, 1700 DIAGONAL ROAD, ALEXANDRIA, VA, 22314, US

(73) Assignee: DAEYANG E & C CO., LTD.,

(21) Appl. No.: 09/873,212

(22) Filed: Jun. 5, 2001

(51) Int. Cl. G09G 5/00

(52) U.S. Cl. 345/7

(57) ABSTRACT

The present invention relates to a head mounted display which is constructed such that stereoscopic images can be seen on a liquid crystal display screen disposed adjacent to eyes, and more particularly, to an optical system for the head mounted display wherein image resolution can be enhanced and a distortion phenomenon caused by eye's movement can be minimized. The optical system for the head mounted display according to the present invention comprises a light source, an illuminating prism for refracting and dispersing light rays emitted from the light source, a polarizer for polarizing the light rays emitted from the illuminating prism, a polarization beam splitter for separating the light rays emitted from the polarizer by polarizations thereof, a reflective liquid crystal display screen on which images are displayed by means of reflecting the light rays emitted from the polarization beam splitter, an eye lens disposed in front of the polarization beam splitter for magnifying the images on the liquid crystal display screen, and safety spectacles disposed in front of the eye lens.

### FIELD OF THE INVENTION

The present invention relates to a head mounted display which is constructed such that stereoscopic images can be seen on a liquid crystal display screen disposed adjacent to eyes, and more particularly, to an optical system for the head mounted display wherein image resolution can be enhanced and a distortion phenomena caused by eye's movement can be minimized.

### BACKGROUND OF THE INVENTION

As well known, the head mounted display is an apparatus for providing a feeling as if a wearer existed in a virtual space through various kinds of sensors for detecting changes of direction of a face and liquid crystal display screen installed within the display.

The head mounted display can be used not only for playing an entertainment game but also for providing beforehand a wearer various experiences about various situations in many fields of industry such as architecture and interior design. In particular, a more realistic and vivid virtual reality system has been recently developed and utilized by combining the head mounted display with various interface devices such as a body suit which can detect a movement of a human body.

On the other hand, such a head mounted display includes an optical system comprising elements such as a liquid crystal display screen, illuminating device and lenses. The optical system allows images to be displayed on the liquid crystal display screen and to be visually recognized through the optical system. The system can be variously constructed depending on an arrangement of the elements for constituting the optical system.

Optical systems used generally in the prior art are schematically shown in FIGS. 1 and 2. Taking the figures into consideration, the optical system of FIG. 1 is constructed in such a manner that an illuminating device 2 serving as a light source of a liquid crystal display screen 1 for displaying image is disposed behind the liquid crystal display screen 1 and that an eye lens 3 is disposed in front of the liquid crystal display screen 1.

Further, the optical system of FIG. 2 is constructed in such a manner that a liquid crystal display screen 1 is horizontally disposed to face downward, that a polarization beam splitter 4 is disposed at an angle of about 45° and vertically below the liquid crystal display screen 1, and that a concave reflecting mirror 5 for magnifying and reflecting an image of the liquid crystal display screen 1 is disposed behind the polarization beam splitter 4. Here, the illuminating device 2 is also disposed behind the liquid crystal display screen 1 in the same manner as in FIG. 1. Furthermore, the liquid crystal display screens 1 of FIGS. 1 and 2 are transmissive liquid crystal display screens and can be used to display the image by using the illuminating devices 2 behind the screens as light sources and transmitting light emitted therefrom.

Although the conventional optical systems constructed as described above have advantages in that a slim and compact apparatus can be obtained since its constitution is simple, there is still a disadvantage in that the production costs thereof are high since the expensive transmissive liquid crystal display screen 1 should be utilized as mentioned above. Further, there is another disadvantage in that light efficiency thereof is low because the light source should cover an entire rear face of the transmissive liquid crystal display screen 1 to provide all pixels of the screen 1 uniform light. In particular, although the optical system of FIG. 2 has an advantage over the optical system of FIG. 1 in that image visibility thereof can be enhanced by means of the polarization beam splitter 4, there is a problem in that a reflection of a viewer's own eye shape can be seen in the concave reflecting mirror 5.

Another example of an optical system for a head mounted display is shown in FIG. 3. This optical system is constructed in such a manner that a liquid crystal display screen 6 is vertically disposed, that an eye lens 7 is disposed in front of the liquid crystal display screen 6, and that a polarization beam splitter 8, which faces downward at an angle of about 45° toward the liquid crystal display screen 6, is disposed between the liquid crystal display screen 6 and the eye lens 7. Here, the liquid crystal display screen 6 is a reflective liquid crystal display screen, and is constructed to receive light emitted from an illuminating device 9 disposed above and in front of the screen through the polarization beam splitter 8 and to display an image.

On the other hand, there was an advantage of the optical system of FIG. 3, in that its light efficiency is improved and a relatively better image for considering the production costs can be obtained since the inexpensive reflective liquid crystal display screen having many pixels has been utilized. However, there was a shortcoming in the optical system of FIG. 3, in that it is sized to become relatively larger than the optical systems of FIGS. 1 and 2 since the space for installing the illuminating device 9, the polarization beam splitter 8, the liquid crystal display screen 6 and the eye lens 7 should be secured. Further, since the eye lens 7 of the optical system of FIG. 3 should be designed to be very thick such that its focal length is short in order to have the same effect that is obtained when a screen having a size of 40 inches is seen at a distance of 2 meters, eye relief, which is defined as a distance between an eye lens and a pupil, becomes short and an exit pupil diameter becomes also short. Thus, there is still a problem in that slight movement of the eye makes an image of a peripheral portion be unseen.

### SUMMARY OF THE INVENTION

Accordingly, the present invention is contemplated to solve the above problems. An object of the present invention is to provide an optical system for a head mounted display, wherein an optimum image can be seen to a wearer by minimizing a distortion phenomenon due to eye's movement and by increasing image resolution.

In order to achieve the above object, the present invention provides an optical system for a head mounted display, which comprises a light source, an illuminating prism for refracting and dispersing light rays emitted from the light source, a polarizer for polarizing the light rays emitted from the illuminating prism, a polarization beam splitter for separating the light rays emitted from the polarizer by polarizations thereof, a reflective liquid crystal display screen on which images are displayed by means of reflecting the light rays emitted from the polarization beam splitter, an eye lens disposed in front of the polarization beam splitter for magnifying the images on the liquid crystal display screen, and safety spectacles disposed in front of the eye lens.

### BRIEF DESCRIPTION OF THE DRAWINGS

FIG. 1 is a schematic view showing the constitution of a conventional optical system for a head mounted display.

FIGS. 2 and 3 are schematic views showing the other examples of conventional optical systems for head mounted displays.

FIG. 4 is a schematic view showing the constitution and arrangement of an optical system for a head mounted display according to a preferred embodiment of the present invention.

FIG. 5 is a side sectional view showing an example of a head mounted display in which the preferred optical system of the present invention is installed.

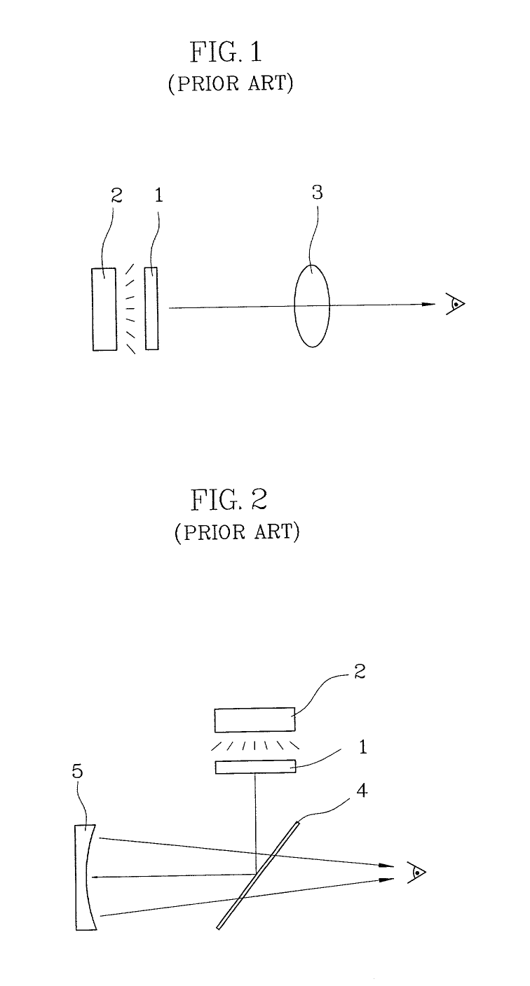

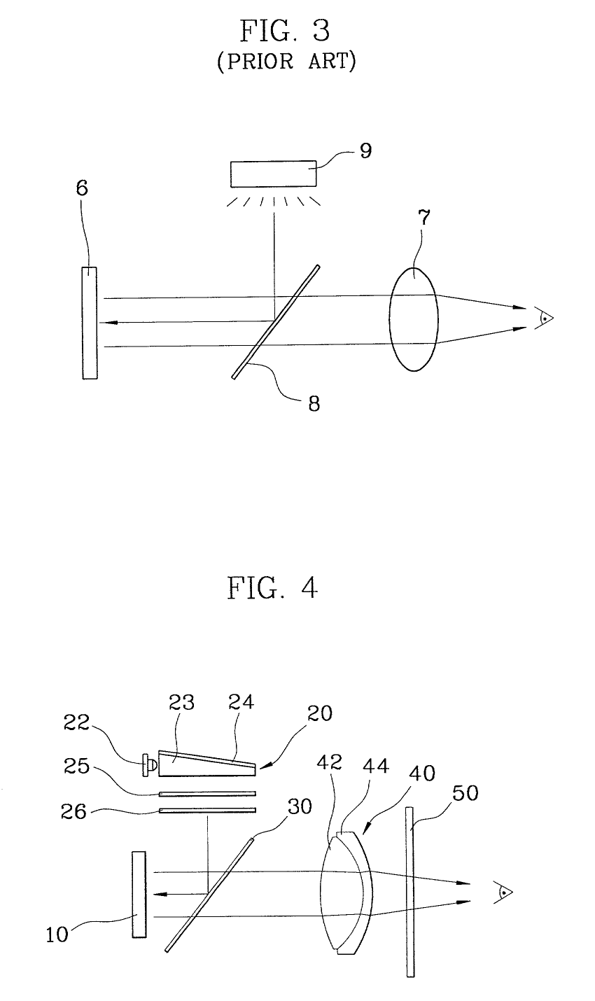

### DETAILED DESCRIPTION FOR PREFERRED EMBODIMENT

Hereinafter, a preferred embodiment of an optical system for a head mounted display according to the present invention will be explained in detail with reference to the accompanying drawings.

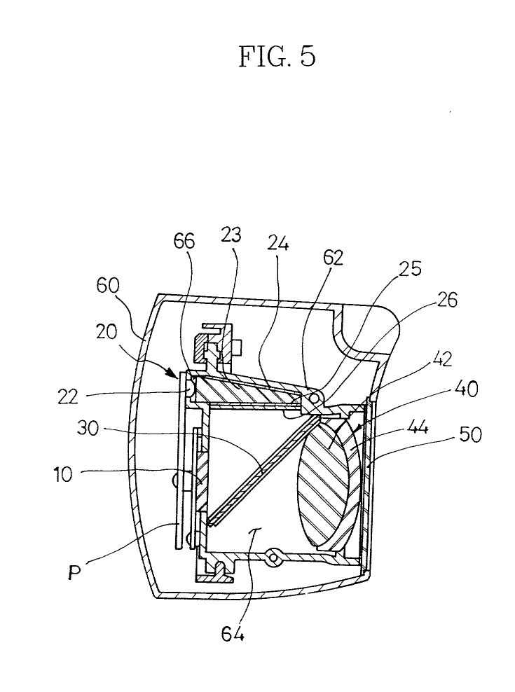

FIG. 4 is a view showing schematically the constitution and arrangement of an optical system for the head mounted display according to a preferred embodiment of the present invention, and FIG. 5 is a side sectional view of an example of the head mounted display in which the preferred optical system of the present invention is installed. First, as shown in FIG. 4, a liquid crystal display screen 10 for displaying an image is vertically disposed in the optical system for the head mounted display according to the present invention. The liquid crystal display screen 10 is a reflective liquid crystal display screen for displaying the image by using illumination, irradiated from the front of the screen, as a light source.

Further, an illuminating portion 20 for providing the light source to the liquid crystal display screen 10 is disposed above the liquid crystal display screen 10. The illuminating portion 20 mainly comprises a light emitting diode 22, an illuminating prism 23, and a plurality of sheets 24 to 26. More specifically, the light emitting diode 22 for providing the light source to the liquid crystal display screen 10 is disposed in parallel with the liquid crystal display screen 10 vertically above the screen 1 0(facing the same direction as the screen 10), and the illuminating prism 23 for refracting and dispersing light rays emitted from the light emitting diode 22 is installed in front of the light emitting diode 22.

Furthermore, the reflecting sheet 24 for reflecting again the light rays, which are not refracted but transmitted by the illuminating prism 23, is disposed at the top of the illuminating prism 23. The prism sheet 25 for focusing the light rays refracted by the illuminating prism 23 and a polarizer corresponding to the sheet 26 for polarizing the light rays emitted again through the prism sheet 25 are sequentially disposed below the illuminating prism 23. Here, the prism sheet 25 focuses the light rays emitted diffusively from the reflecting sheet 24 at an angle of about 70° to irradiate the liquid crystal display screen 10. The polarizer 26 is installed ahead of the polarization beam splitter 30 and adjusts the contrast of the image to perform an auxiliary function of the polarization beam splitter 30.

On the other hand, the polarization beam splitter 30 is disposed at an angle of about 45° in front of the liquid crystal display screen 10. The polarization beam splitter 30 transmits an imperfectly polarized component of luminous flux, which passes through the polarizer 26 and is polarized in a specific direction, and it reflects only a perfectly polarized component onto the liquid crystal display screen 10. And, an eye lens 40 for enabling a viewer to see a magnified image of the liquid crystal display screen 10 is installed in front of the polarization beam splitter 30.

As shown in FIG. 4, the eye lens 40 is an achromatic lens formed by combining a convex lens 42 and a concave lens 44 such that a chromatic aberration phenomenon that images are formed at different points depending on their colors cannot be produced. Further, since the last lens of the achromatic lens is formed to be aspheric, it can increase image resolution and correct distortion aberration corresponding to a phenomenon that images are distorted as they go far away from the center of the lens. In particular, in the present invention, using lenses having one or more aspheric surfaces can reduce the distortion aberration due to the eye's movement. This eye lens 40 is disposed so that the concave lens 44 faces an eye of the wearer and the convex lens 42 faces the liquid crystal display screen 10, and thus, takes a retro-focus form by which a focus in a direction of the liquid crystal display screen 10 can be lengthened. Therefore, the eye lens can be constructed to sufficiently secure the space for installing the polarization beam splitter 30.

According to the eye lens 40 constructed as such, for example, the viewer can feel as if he/she viewed 44-inch images on the liquid crystal display screen 10 at a distance of about 2 meters. In particular, the eye lens 40, i.e., the combined achromatic lens, lengthens the eye relief or exit pupil distance and enlarges the magnitude of the exit pupil diameter. Thus, even though the viewer moves his own eye, the images of the peripheral portions can be correctly seen. In addition, with the eye lens 40, i.e., the combined achromatic lens, a vignetting phenomenon that brightness of the peripheral portions of the images is lower than that of the central portion due to an off-axis light rays passing through the lens at an oblique angle to an optical axis can be nearly avoided.

Furthermore, safety spectacles 50 are disposed between the eye lens 40 and the viewer's eye, and minimize introduction of the light ray, reflected from the eye lens 40, into the viewer's eye.

The operation and advantageous effects of the present invention constructed as such will be described in detail. When the light rays are generated from the light emitting diode 22 under the condition that image signals are applied to the liquid crystal display screen 10, the light rays are refracted and dispersed while passing through the illuminating prism 23 and then they arrive at the polarization beam splitter 30. At this time, some portions of the light rays, which are not refracted and are transmitted through the illuminating prism 23, are reflected by the reflecting sheet 24 and are directed to the polarization beam splitter 30. The light rays passing through the illuminating prism 23 along the above path are focused through the prism sheet 25 and the polarizer 26, and thus brightness and polarization direction thereof are adjusted. Further, the light rays passing through the prism sheet 25 and the polarizer 26 are separated into two components that are reflected by or transmitted through the polarization beam splitter 30, and only the light rays having a desired polarization direction are reflected by the liquid crystal display screen 10.

The images are displayed on the liquid crystal display screen 10 by using the light rays, which pass through the above path and arrive at the screen, as the light source. Then, the viewer wearing the head mounted display can see the images on the liquid crystal display screen 10 through the eye lens 40. At this time, the images on the liquid crystal display screen 10 are magnified to an extent that the viewer sees, for example, the 44-inch images at a distance of about 2 meters. In particular, since the eye lens, i.e. the combined achromatic lens, lengthens the eye relief and enlarges the exit pupil diameter, the wearer can view more stable images on the liquid crystal display screen 10. Further, use of the reflective liquid crystal display screen can provide a good image resolution at a low cost, and use of the combined achromatic lens can also make the distortion aberration be corrected. Therefore, the viewer wearing the head mounted display according to the present invention can view more clear and vivid images.

On the other hand, a head mounted display in which an optical system of the present invention constructed as such is installed is shown in FIG. 5. Referring briefly to this figure, a pair of body tubes 62 are installed within a housing 60 of the head mounted display (Sectional view of any one of both body tubes is shown in FIG. 5). And, the optical system described above is installed in the body tubes 62.

In other words, each of the body tubes 62 has a first installation space 64 with a front end opened, and a second installation space 66 formed above the first installation space 64 to communicate with the first installation space 64. Referring FIG. 5, it is understood that the liquid crystal display screen 10 for displaying the images is installed at the back end of the first installation space 64 and that the eye lens 40 for magnifying the images on the liquid crystal display screen 10 is also installed at the opened front end thereof. Further, the polarization beam splitter 30 is installed between the liquid crystal display screen 10 and the eye lens 40 to be inclined to the liquid crystal display screen 10 at an angle of about 45°.

On the other hand, the illuminating portion 20 is installed in the second installation space 66 of the body tube 62. That is, the light emitting diode 22 serving as the light source for the liquid crystal display screen 10 is installed within the second installation space 66 to be parallel with the liquid crystal display screen 10, and the illuminating prism 23 for downwardly refracting the light rays from the light emitting diode 22 is installed in front of the light emitting diode 22. The reflecting sheet 24 is disposed on the top surface of the illuminating prism 23, and the prism sheet 25 and the polarizer 26 are in turn installed on the bottom surface of the illuminating prism 23. On the other hand, the safety spectacles 50 are installed in front of the eye lens 40 within the housing 60, and a printed circuit board P for controlling both the liquid crystal display screen 10 and the light emitting diode 22 may be installed at the rear surface of the body tube 62.

As described above, the optical system of the present invention is disposed in the housing 60 of the head mounted display and provides the wearer with the best images. In particular, as shown in the figures, since the illuminating portion 20 is disposed parallel with the liquid crystal display screen 10 and can be constructed to have a low height thereof, it is understood that the entire height of the head mounted display can be reduced. One effect of the present invention mentioned above will be obtained by using the illuminating prism 23, the reflecting sheet 24, the prism sheet 25, the polarizer 26, etc. in order to make the utmost use of the light rays from the light emitting diode 22.

As described above, according to the optical system for the head mounted display according to the present invention, there is an advantageous effect in that the light efficiency can be enhanced by using the illuminating prism, the reflecting sheet, the prism sheet, the polarizer, etc. in order to make the utmost use of the light rays from the light emitting diode.

Further, the height of the illuminating portion and the entire height of the system can be reduced and thus miniaturization of the system can be obtained by illuminating the liquid crystal display screen using the prism and the light emitting diode that is disposed parallel with the liquid crystal display screen.

Furthermore, image resolution can be enhanced and distortion aberration can also be corrected, by using the combined achromatic lens having aspheric surfaces. Therefore, more clear and vivid images can be provided to the wearer of the head mounted display according to the present invention.

In general, the above-identified embodiment is not to be construed as limiting the breadth of the present invention. Modifications and other alternative constructions, which are within the spirit and scope of the invention as defined in the appended claims, will be apparent to a person having an ordinary skill in the art.

What is claimed is:

1. An optical system for a head mounted display, comprising:
a light source;
an illuminating prism for refracting and dispersing light rays emitted from said light source;
a polarizer for polarizing said light rays emitted from said illuminating prism;
a polarization beam splitter for separating said light rays emitted from said polarizer by polarizations thereof;
a reflective liquid crystal display screen on which images are displayed by means of reflecting said light rays emitted from said polarization beam splitter;
an eye lens disposed in front of said polarization beam splitter for magnifying said images on said liquid crystal display screen; and
safety spectacles disposed in front of said eye lens.

2. The optical system for the head mounted display as set forth in claim 1, wherein said light source is a light emitting diode disposed near and above the top edge of said liquid crystal display screen to face the same direction as said screen.

3. The optical system for the head mounted display as set forth in claim 1, wherein said eye lens is constructed by combining a concave lens and a convex lens together for avoiding chromatic aberration, and wherein said concave lens has an aspheric surface for avoiding distortion aberration.

4. The optical system for the head mounted display as set forth in claim 1, further comprising a prism sheet for focusing said light rays emitted from said illuminating prism.
